(19) United States
(12) Patent Application Publication
(10) Pub. No.: US 2022/0017076 A1
(43) Pub. Date: Jan. 20, 2022

(54) DRIVE ASSIST DEVICE AND PROGRAM

(71) Applicant: Faurecia Clarion Electronics Co., Ltd., Saitama-shi (JP)

(72) Inventor: Hideyuki SUZUKI, Saitama (JP)

(73) Assignee: Faurecia Clarion Electronics Co., Ltd., Saitama-shi (JP)

(21) Appl. No.: 17/377,836

(22) Filed: Jul. 16, 2021

(30) Foreign Application Priority Data
Jul. 17, 2020 (JP) 2020-122977

(51) Int. Cl. B60W 30/06; G01C 21/34; G01C 21/36; B60W 30/18; B60W 40/08

(52) U.S. Cl. CPC B60W 30/06; G01C 21/3415; B60W 40/08; G01C 21/3691; B60W 30/18109; G01C 21/367

(57) ABSTRACT

It can be estimated accurately whether deceleration is intended to deviate from a scheduled route, and a drive assist can be performed in accordance with the estimated intention. A device includes: a route information acquisition unit configured to acquire route information containing a recommended route for a vehicle to travel to a destination; a deceleration detection unit configured to detect a deceleration operation or deceleration of the vehicle; a deceleration necessity determination result acquisition unit configured to acquire a result of deceleration necessity determination on whether deceleration is necessarily forced, based on a vehicle surrounding environment and the route information; and an estimation unit configured to estimate a prescribed deceleration intension in a case where deceleration of the vehicle or a deceleration operation is detected and the result of deceleration necessity determination indicates that deceleration is unnecessary, and execute processing for a drive assist in accordance with a result of the estimation.

### BACKGROUND

The present invention relates to a drive assist device and a program.

JP 2002-181577 A (PTL 1) relates to a navigation device, and describes that “the navigation device includes a system control unit that sets a scheduled route along which a vehicle is planned to travel, estimates whether the vehicle travels off the scheduled route in traveling of the vehicle along the set scheduled route, and starts setting a scheduled route along which the vehicle is planned to travel after the deviation from the previous scheduled route when the vehicle is estimated to travel off the previous scheduled route.”
PTL 1: JP 2002-181577 A

### SUMMARY

When detecting deceleration before a crossing while traveling along the rightmost or leftmost lane, the navigation device of JP 2002-181577 A estimates that the vehicle is to deviate from the scheduled route, and executes advanced reroute processing. However, deceleration of the vehicle may be caused by various reasons such as a following distance to a vehicle traveling ahead and presence of a pedestrian walking ahead. Thus, estimation of deviation from the scheduled route without considering those factors degrades accuracy, and consequently causes a problem that unnecessary advanced reroute processing increases a processing load of a navigation system.

In view of this, the present invention has an object to accurately estimate whether deceleration is intended to deviate from a scheduled route and to perform a drive assist in accordance with the estimated intention.

The present application includes a plurality of solutions to at least a part of the above-mentioned problem. One example of the solutions is as follows. A drive assist device according to one aspect of the present invention to solve the above-mentioned problem includes: a route information acquisition unit configured to acquire route information containing a recommended route for a vehicle to travel to a destination; a deceleration detection unit configured to detect a deceleration operation or deceleration of the vehicle; a deceleration necessity determination result acquisition unit configured to acquire a result of deceleration necessity determination on whether deceleration is necessarily forced, based on a vehicle surrounding environment and the route information; and an estimation unit configured to estimate a prescribed deceleration intension in a case where deceleration of the vehicle or a deceleration operation is detected and the result of deceleration necessity determination indicates that deceleration is unnecessary, and execute processing for a drive assist in accordance with a result of the estimation.

The device may further include a storage unit configured to store map information, wherein the estimation unit, in the case where deceleration of the vehicle or the deceleration operation is detected and the result of deceleration necessity determination indicates that deceleration is unnecessary, may determine whether an intersection is present near the vehicle by using the map information, and the route information acquisition unit, when it is determined that the intersection is present, may acquire a rerouting route for taking a turn at the intersection and traveling to the destination.

The device may further include an output processing unit configured to generate screen information to be displayed on a display device, wherein when the vehicle travels to a road on the rerouting route after turning at the intersection, the output processing unit may display the rerouting route on the display device.

The device may further include a storage unit configured to store map information, wherein the estimation unit, in the case where deceleration of the vehicle or the deceleration operation is detected and the result of deceleration necessity determination indicates that deceleration is unnecessary, may determine whether a direction indicator of the vehicle flashes and whether a prescribed facility is present in a direction indicated by the direction indicator, by using the map information, and when it is determined that the prescribed facility is present, may specify information relating to the facility.

The device may further include an output processing unit configured to generate screen information to be displayed on a display device, wherein the output processing unit may display information relating to the facility being specified, on the display device.

The device may further include a storage unit configured to store map information, wherein the estimation unit, in the case where deceleration of the vehicle or the deceleration operation is detected and the result of deceleration necessity determination indicates that deceleration is unnecessary, may determine whether a direction indicator of the vehicle flashes and whether a prescribed facility is present in a direction indicated by the direction indicator, by using the map information, and when it is determined that the direction indicator does not flash, or it is determined that the prescribed facility is not present, may specify a navigation route to a place allowing safe stopping/parking, by using the map information.

The device may further include an output processing unit configured to generate screen information to be displayed on a display device, wherein the output processing unit may display a navigation route to the place being specified, on the display device.

The device may further include: a communication unit configured to communicate with an automatic drive control unit that is configured to control the vehicle to execute automatic drive; and a storage unit configured to store map information, wherein the estimation unit, in the case where deceleration of the vehicle or the deceleration operation is detected and the result of deceleration necessity determination indicates that deceleration is unnecessary, may determine whether a direction indicator of the vehicle flashes and whether a prescribed facility is present in a direction indicated by the direction indicator, by using the map information, and when it is determined that the direction indicator does not flash, or it is determined that the prescribed facility is not present, may specify a navigation route to a place allowing safe stopping/parking, and the communication unit may transmit an instruction, to the automatic drive control unit, for causing the vehicle to travel to the place being specified, through automatic drive.

The deceleration necessity determination may be executed by an automatic drive control unit configured to control the vehicle to execute automatic drive.

A program according to one aspect of the present invention causing a computer to function as a drive assist device, the program causing the computer to function as: a route information acquisition unit configured to acquire route information containing a recommended route for a vehicle to travel to a destination; a deceleration necessity determination result acquisition unit configured to acquire a result of deceleration necessity determination on whether deceleration is necessarily forced, based on a vehicle surrounding environment and the route information; a deceleration detection unit configured to detect a deceleration operation or deceleration of the vehicle; and an estimation unit configured to estimate a prescribed deceleration intension in a case where deceleration of the vehicle or a deceleration operation is detected and the result of deceleration necessity determination indicates that deceleration is unnecessary, and execute processing for a drive assist in accordance with a result of the estimation.

According to the present invention, it can be estimated accurately whether deceleration is intended to deviate from a scheduled route, and a drive assist can be performed in accordance with the estimated intention.

Note that a problem, a configuration, an effect, and the like other than those described above will be apparent from the description of embodiments given below.

### BRIEF DESCRIPTION OF DRAWINGS

FIG. 1 is a functional block diagram illustrating an example of a functional configuration of a drive assist device and an automatic drive control system that are included in a drive assist system.

FIG. 2 is a diagram illustrating an example of a hardware configuration of the drive assist device.

FIG. 3 is a diagram illustrating an example of a hardware configuration of the automatic drive control device.

FIG. 4 is a flowchart illustrating an example of drive assist processing executed by the drive assist device.

FIG. 5 is a diagram illustrating an outline of reroute processing.

FIG. 6 is a diagram illustrating an outline of processing for displaying facility information.

FIG. 7 is a diagram illustrating an outline of processing for switching to automatic drive and causing a vehicle to travel.

### DESCRIPTION OF EMBODIMENTS

One embodiment of the present invention is described below.

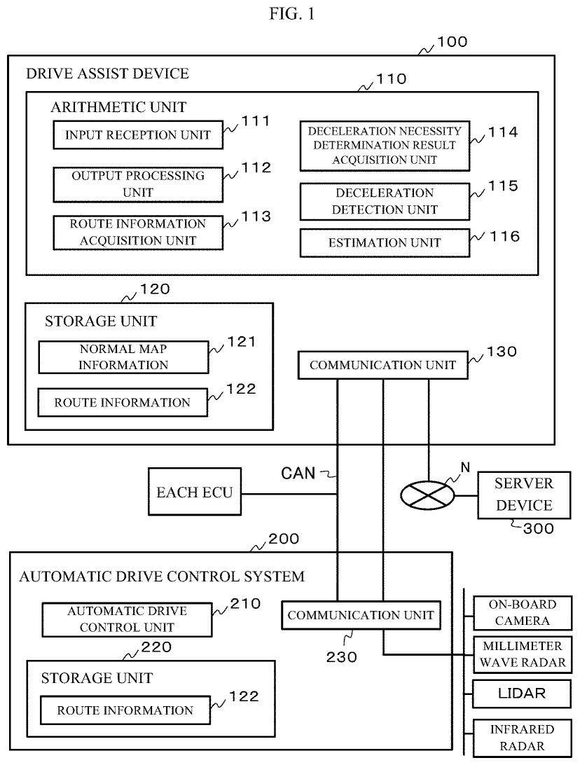

FIG. 1 is a functional block diagram illustrating an example of a functional configuration of a drive assist device 100 and an automatic drive control system 200 that are included in a drive assist system. As illustrated, the drive assist system includes the drive assist device 100 and the automatic drive control system 200.

The drive assist device 100 and the automatic drive control system 200 are connected to each other in a mutually communicable manner via a controller area network (CAN) and a wired communication cable. The drive assist device 100 is connected to a server device 300 in a mutually communicable manner via a prescribed network N including a public network such as the Internet, a local area network (LAN), and/or a wide area network (WAN).

The drive assist device 100 is a navigation device that provides a user with so-called navigation functions such as display of a recommended route connecting a departure point and a destination to each other, display of map information and traffic information, and route guidance with spoken guidance using the recommended route.

The automatic drive control system 200 is a system that controls automatic drive of a vehicle by using information acquired from various sensors and devices installed on the vehicle. Here, the automatic drive refers to a technique of constantly recognizing a vehicle surrounding environment by using information acquired from various sensors and devices installed on the vehicle, such as a camera, a millimeter wave radar, a light detection and ranging (LIDAR) and an infrared radar, and a global positioning system (GPS) reception device, and causing the vehicle to move (travel) to a destination by using route information.

The automatic drive control system 200 achieves the automatic drive by outputting to a control signal to various electronic control units (ECUs) that control steering, acceleration, or braking, in accordance with the vehicle surrounding environment recognized through use of the information acquired from the various sensors and devices. Note that it is only required to use a publicly-known technique as a vehicle control method according to the automatic drive.

As illustrated in FIG. 1, the drive assist device 100 includes an arithmetic unit 110, a storage unit 120, and a communication unit 130.

The arithmetic unit 110 is a function unit that executes various types of arithmetic processing of the drive assist device 100. The arithmetic unit 110 includes an input reception unit 111, an output processing unit 112, a route information acquisition unit 113, a deceleration necessity determination result acquisition unit 114, a deceleration detection unit 115, and an estimation unit 116.

The input reception unit 111 is a function unit that receives an input of an instruction or information from a user via an input device included in the drive assist device 100. For example, the input reception unit 111 receives an input of a departure point and a destination and an instruction of searching for a recommended route from a user via the input device.

The output processing unit 112 is a function unit that generates information to be output to a display device or a speaker included in the drive assist device 100. For example, the output processing unit 112 generates screen information for displaying map information, route information, traffic information, or the like on the display device. Moreover, for example, the output processing unit 112 generates spoken voice for spoken guidance, and outputs the spoken voice to a speaker.

The route information acquisition unit 113 is a function unit that acquires route information 122 containing a recommended route from an external device (the server device 300). Specifically, the route information acquisition unit 113 receives the instruction of searching for a recommended route via the input reception unit 111, and then transmits an acquisition request of the route information 122 containing a recommended route to the server device 300 via the communication unit 130. The route information acquisition unit 113 acquires the route information 122 via the communication unit 130, and then stores the route information 122 in the storage unit 120. Note that the route information 122 contains, in addition to the recommended route, map information and facility information around the recommended route.

The deceleration necessity determination result acquisition unit 114 is a function unit that acquires a result of vehicle deceleration necessity determination executed in the automatic drive control system 200.

The deceleration detection unit 115 is a function unit that detects a deceleration operation of a user being a driver or vehicle deceleration. Specifically, through acquisition of via the communication unit 130, information indicating that a deceleration operation is performed (for example, information indicating that a brake pedal is stepped on or information indicating that a gear position is shifted down), via the CAN, the deceleration detection unit 115 detects that a vehicle deceleration operation is performed. Note that the information indicating that a deceleration operation is performed is output to the CAN from, for example, a brake ECU that controls a brake pedal or an ECU that controls a gear position, and is acquired by the deceleration detection unit 115 through the communication unit 130. The deceleration detection unit 115 detects, based on information output from a vehicle speed sensor, reduction in vehicle speed to a slow-down level (for example, equal to or slower than 20 km/h) when, for example, the vehicle turns right or left at an intersection or the like, or is stopped at a road shoulder, and thus detects vehicle deceleration.

The estimation unit 116 is a function unit that estimates an intention of a user being a driver and executes an operation assist in accordance with the estimation result. Specifically, in a case where a deceleration operation or vehicle deceleration is detected, when the automatic drive control system 200 determines that vehicle deceleration is unnecessary, the estimation unit 116 estimates an intension of a user for deceleration, based on the vehicle surrounding environment, and executes prescribed processing in accordance with the estimation result. Specifically, in a case where a deceleration operation is performed although the automatic drive control system 200 determines that there is no reason for preventing the vehicle from traveling straight, the estimation unit 116 estimates an intension for deceleration based on the vehicle surrounding environment, and executes processing of providing information estimated to be desired by a user or the like.

More specifically, when any one of a deceleration operation and vehicle deceleration is detected, the estimation unit 116 acquires, through the deceleration necessity determination result acquisition unit 114, a result of determination on whether the automatic drive control system 200 determines vehicle deceleration is unnecessary (deceleration necessity determination). When the determination result indicates that determination of unnecessary of vehicle deceleration, the estimation unit 116 estimates an intention for deceleration of a user, and executes prescribed processing.

The storage unit 120 is a function unit that stores various types of information required for providing the navigation functions. Specifically, the storage unit 120 stores the normal map information 121 and the route information 122 containing a recommended route that is searched by the server device 300 by using highly accurate map information.

The normal map information 121 contains detailed information relating to roads. Specifically, the normal map information 121 contains link information in which, for each prescribed region obtained by segmenting the map, detailed information on roads in the region is stored. The link information contains various types of information such as a start node and an end node of a road, a road type, a road name, a link length, a travel time, and lane information, which are used for a route search and route guidance using the recommended route. The normal map information 121 contains detailed information relating to facilities and shops on the map. Note that the normal map information 121 contains less information than the highly accurate map information, and thus is not used for automatic drive of the vehicle.

The route information 122 is information containing the recommended route that is searched by using the highly accurate map information. Note that the highly accurate map information is map information used for automatic drive of the vehicle, and contains more detailed information on roads than the normal map information 121. For example, in addition to the information contained in the normal map information 121, the highly accurate map information contains more detailed information on roads used for automatic drive, including the number of lanes, lane information indicating a lane number, lane characteristic information indicating characteristics associated with a lane (for example, a lane for a right turn or a lane for a left turn), marking information indicating types of lane markings (broken lines or solid lines) and colors (white or orange), lane width information indicating a width of a lane, and traffic sign information indicating types of traffic signs associated with a lane (such as No U-turns and Stopping/Parking Prohibited). The route information 122 is generated by using such highly accurate map information, and contains information required for automatic drive, which is contained in the highly accurate map information.

The communication unit 130 is a function unit that executes information communication with external devices (the automatic drive control system 200 and the server device 300). Specifically, the communication unit 130 transmits a request for acquiring the route information 122 to the server device 300, and acquires the information from the server device 300. Via the CAN, the communication unit 130 acquires information indicating that a deceleration operation is performed.

Via the communication cable or the CAN, the communication unit 130 acquires a result of necessity determination on vehicle deceleration from the automatic drive control system 200. In a certain case, the communication unit 130 transmits, to the automatic drive control system 200, an instruction of switching vehicle manual drive by a user to automatic drive by the automatic drive control system 200.

The functional blocks of the drive assist device 100 are described above.

As illustrated in FIG. 1, the automatic drive control system 200 includes an automatic drive control unit 210, a storage unit 220, and a communication unit 230.

The automatic drive control unit 210 is a function unit that controls automatic drive of the vehicle. Specifically, the automatic drive control unit 210 recognizes a vehicle surrounding environment by using information acquired from various sensors and devices installed on the vehicle, such as a millimeter wave radar, a LIDAR and an infrared radar, an on-board camera, and a GPS reception device. The automatic drive control unit 210 controls the vehicle by outputting a control signal to various ECUs that control steering, acceleration, or braking, in accordance with the vehicle surrounding environment, and causes the vehicle to travel to a destination through the automatic drive along the recommended route.

The automatic drive control unit 210 receives an instruction of switching between an automatic drive mode and a manual drive mode by a user, via an input device installed on the vehicle. When the automatic drive mode is set, the automatic drive control unit 210 executes the automatic drive. When the manual drive mode is set, the automatic drive control unit 210 does not execute the automatic drive, but executes frontward confirmation determination described later and deceleration necessity determination in the background. Note that the automatic drive control unit 210 transmits a type of the set drive mode to the drive assist device 100 via the communication unit 230.

For each determination processing, the automatic drive control unit 210 acquires image (video) information from an on-board camera via the communication unit 230, and recognizes presence of other vehicles, a pedestrian, and an obstacle around the vehicle, and a lighting color of a traffic light ahead of the vehicle by using the information.

The automatic drive control unit 210 acquires output information via the communication unit 230 from any one of the on-board sensors including a millimeter wave radar, a LIDAR and an infrared radar, and calculates a distance from the own vehicle to another vehicle, a pedestrian, or an obstacle being present ahead by using such information.

The automatic drive control unit 210 executes frontward confirmation determination by using information acquired from an on-board camera and various sensors. Specifically, the automatic drive control unit 210 determines whether another vehicle, a pedestrian, or an obstacle is present ahead (a first confirmation target), whether a following distance to a vehicle traveling ahead is enough (a second confirmation target), and whether a lighting color of a traffic light, if being present ahead, is blue (a third confirmation target).

The automatic drive control unit 210 acquires information output from a GPS reception device and the route information 122 via the communication unit 230 from the drive assist device 100, and specifies an own vehicle position (current position) on the recommended route by using those pieces of information.

The automatic drive control unit 210 executes deceleration necessity determination whether vehicle deceleration is necessary or unnecessary based on the result of frontward confirmation determination and the own vehicle position. Specifically, the automatic drive control unit 210 determines that vehicle deceleration is unnecessary when a vehicle traveling ahead is not present or a sufficient following distance is enough from a vehicle traveling ahead, a pedestrian or an obstacle is not present ahead, a lighting color of a traffic light, if present ahead, is blue, and an intersection at which the vehicle is to turn right or left along the recommended route is not present within a prescribed range from the own vehicle position (for example, within 100 m).

Meanwhile, the automatic drive control unit 210 determines that vehicle deceleration is necessary when satisfying any one of the conditions including a case where a following distance is not enough from a vehicle traveling ahead, a case where a pedestrian or an obstacle is present ahead, a case where a lighting color of a traffic signal, if being present ahead, is yellow or red, and a case where the own vehicle position is near an intersection at which the vehicle turns right or left along the recommended route.

The automatic drive control unit 210 executes such deceleration necessity determination periodically (for example, every second), and transmits the determination result to the drive assist device 100 via the communication unit 230. Note that the automatic drive control unit 210 may transmit the determination result to the drive assist device 100 via the communication unit 230 only in a case where deceleration is determined to be unnecessary. In this manner, the automatic drive control unit 210 is not required to execute processing of transmitting the determination result periodically. Alternatively, the automatic drive control unit 210 may hold the result of deceleration necessity determination as a status, and the drive assist device 100 may perform polling to the automatic drive control unit 210 via the communication unit 130. Similarly, in this case, the automatic drive control unit 210 is not required to execute processing of transmitting the determination result periodically.

The storage unit 220 is a function unit that stores various types of information required for automatic drive control. Specifically, the storage unit 220 stores the route information 122 that is acquired from the drive assist device 100 via the communication unit 230.

The communication unit 230 is a function unit that executes information communication with the drive assist device 100 or an external device (for example, a drive assist device 100). Specifically, the communication unit 230 acquires the route information 122 from the drive assist device 100. The communication unit 230 transmits the result of deceleration necessity determination to the drive assist device 100. The communication unit 230 acquires an instruction of switching the drive mode from the drive assist device 100. The communication unit 230 transmits a type of the set drive mode to the drive assist device 100. Note that these pieces of information may be directly transmitted to the drive assist device 100 via the communication cable, or may be transmitted to the drive assist device 100 via the CAN.

The functional blocks of the automatic drive control system 200 are described above.

Next, hardware configurations of the drive assist device 100 and the automatic drive control system 200 are described.

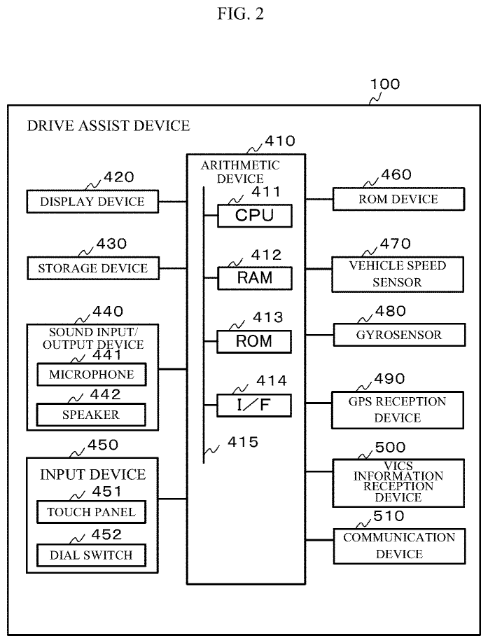

FIG. 2 is a diagram illustrating an example of a hardware configuration of the drive assist device 100. As illustrated, the drive assist device 100 includes an arithmetic device 410, a display device 420, a storage device 430, a sound input/output device 440, an input device 450, a ROM device 460, a vehicle speed sensor 470, a gyrosensor 480, a GPS reception device 490, a VICS information reception device 500, and a communication device 510.

The arithmetic device 410 is a central unit that executes various types of processing of the drive assist device 100. Specifically, the arithmetic device 410 executes processing for achieving so-called navigation functions. More specifically, the arithmetic device 410 detects a current position by using information output from various types of sensors such as the vehicle speed sensor 470 and the GPS reception device 490. The arithmetic device 410 reads out the normal map information 121 and the route information 122 from the storage device 430, develops the information into graphics, superposes a mark indicating the current position thereon, and displays the resultant on the display device 420.

In a case where a deceleration operation of a driver (a user) or vehicle deceleration is detected, when the automatic drive control system 200 determines that vehicle deceleration is unnecessary, the arithmetic device 410 estimates an intention for deceleration of a user, and executes prescribed processing in accordance with the estimation result.

The arithmetic device 410 as described above has a configuration connected with the devices via a bus 415. Specifically, the arithmetic device 410 includes a central processing unit (CPU) 411 that executes arithmetic processing, a random access memory (RAM) 412 that temporarily stores various types of information read out from the storage device 430 or the ROM device 460, a read only memory (ROM) 413 that stores a program executed by the CPU 411, an interface (I/F) 414 that connects the arithmetic device 410 to each piece of hardware, and the bus 415 that connects these components to one another.

The display device 420 (display) is a unit that displays graphics information, and is configured with, for example, a liquid crystal display or an organic EL display. The storage device 430 is a storage medium such as a hard disk drive (HDD), a solid state drive (SSD), or a non-volatile memory card, which is at least capable of reading and writing, and stores various types of information (for example, the normal map information 121).

The sound input/output device 440 includes a microphone 441 that collects voice sound uttered by a driver or a passenger, and a speaker 442 that outputs spoken guidance for a driver or the like. Note that the speaker 442 may be an on-board speaker installed on the vehicle.

The input device 450 is a device that receives an instruction input from a user, such as a touch panel 451 or a dial switch 452. The ROM device 460 is a storage medium including a ROM such as a CD-ROM and a DVD-ROM or an integrated circuit (IC) card, which is at least capable of reading, and stores moving image data and sound data, for example.

The vehicle speed sensor 470, the gyrosensor 480, and the GPS reception device 490 are used to detect a current position of the vehicle on which the drive assist device 100 is installed. The vehicle speed sensor 470 outputs information used for calculating a vehicle speed. Specifically, the vehicle speed sensor 470 converts the detected number of wheel revolutions into pulse signals, and outputs prescribed information such as the number of pulse signals within a prescribed time period. The gyrosensor 480 is configured with an optical fiber gyro, an oscillation gyro, or the like, and detects an angular speed of rotation of a moving body. The GPS reception device 490 receives a signal from GPS satellites, and measures, with respect to each of the prescribed number of (for example, four) satellites, a distance between the vehicle and the GPS satellite and a change rate of the distance, to measure a current location, an advance speed, and an advance direction of the vehicle.

The VICS information reception device 500 is a device that receives traffic information (VICS information) relating to a traffic jam, an accident, or road construction. The communication device 510 is a communication module that executes information communication with external devices (the automatic drive control system 200 and the server device 300) in wireless or wired communication.

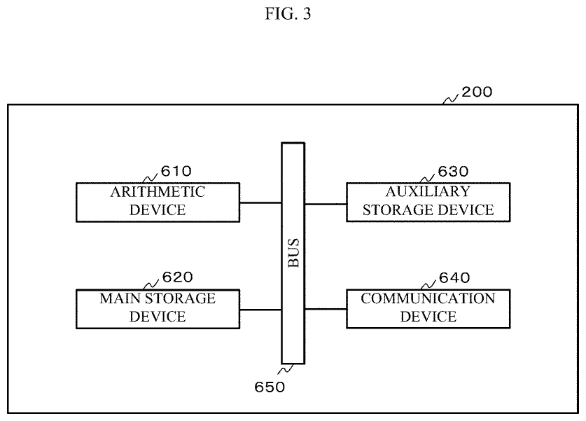

FIG. 3 is a diagram illustrating an example of a hardware configuration of the automatic drive control system 200. As illustrated, the automatic drive control system 200 includes an arithmetic device 610, a main storage device 620, an auxiliary storage device 630, a communication device 640, and a bus 650 that electrically connects those devices to one another.

The arithmetic device 610 is a processing device such as a CPU. The main storage device 620 is a memory device such as a RAM and a ROM. The auxiliary storage device 630 is a so-called hard disk or a non-volatile storage device such as an SSD or a flash memory that are capable of storing digital information. The communication device 640 is a communication module that executes information communication with external devices in wireless or wired communication.

The hardware configurations of the drive assist device 100 and the automatic drive control system 200 are described above.

Note that the arithmetic unit 110 of the drive assist device 100 is implemented by programs that cause the CPU 411 of the arithmetic device 410 to execute processing. Those programs are stored in, for example, the storage device 430 or the ROM 413. At the time of execution, the programs are loaded on the RAM 412, and are executed by the CPU 411. The storage unit 120 may be implemented with the RAM 412, the ROM 413, or the storage device 430, or may be implemented with a combination of those. The communication unit 130 may be implemented with the VICS information reception device 500 or the communication device 510, or may be implemented with a combination of those.

The automatic drive control unit 210 of the automatic drive control system 200 is implemented with programs that cause the CPU of the arithmetic device 610 to execute processing. Those programs are stored in, for example, the main storage device 620 or the auxiliary storage device 630. At the time of execution, the programs are loaded on the RAM, and are executed by the CPU. The storage unit 220 may be implemented with the main storage device 620 or the auxiliary storage device 630, or may be implemented with a combination of those. The communication unit 230 is implemented with the communication device 640.

For better understanding of each function achieved in the present embodiment, each functional block of the drive assist device 100 and the automatic drive control system 200 is obtained through classification in accordance with a main processing content. Therefore, the way of classifying the functions and the names of the functions do not limit the present invention. Each configuration of the drive assist device 100 and the automatic drive control system 200 may be classified into more components in accordance with a processing content. The components can be classified so that one component executes more processing.

An entirety or a part of respective function units may be constituted by hardware (an integrated circuit such as an ASIC) implemented in a computer. Further, processing of each function unit may be executed by one piece of hardware or plural pieces of hardware.

[Description of Operation]

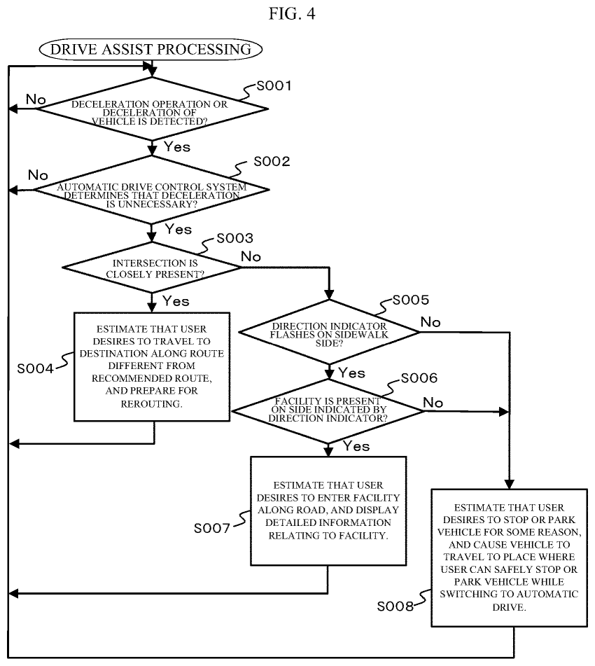

FIG. 4 is a flowchart illustrating an example of drive assist processing executed by the drive assist device 100. The processing is started when the drive assist device 100 acquires the route information 122 and the manual drive mode is set.

When the processing is started, the deceleration detection unit 115 determines whether a deceleration operation of a user or vehicle deceleration is detected (Step S001). when it is determined that such operation or deceleration is not detected (No in Step S001), the deceleration detection unit 115 executes the processing of Step S001 again. Meanwhile, when it is determined that the deceleration operation or vehicle deceleration is detected (Yes in Step S001), the deceleration detection unit 115 proceeds the processing to Step S002.

In Step S002, the estimation unit 116 determines whether the automatic drive control system 200 determines that deceleration is unnecessary. Specifically, the estimation unit 116 acquires the result of deceleration necessity determination by the automatic drive control unit 210 via the deceleration necessity determination result acquisition unit 114, and determines whether the automatic drive control system 200 determines that deceleration is unnecessary. When the automatic drive control system 200 determines that deceleration is necessary (No in Step S002), the estimation unit 116 returns the processing to Step S001. Meanwhile, when the automatic drive control system 200 determines that deceleration is unnecessary (Yes in Step S002), the estimation unit 116 proceeds the processing to Step S003.

In Step S003, the estimation unit 116 determines whether an intersection is closely present. Specifically, while referring to the normal map information 121, the estimation unit 116 determines whether an intersection is present ahead on the road along which the own vehicle travels and within a prescribed distance (for example, within 50 m) from the own vehicle position. When it is determined that an intersection is not present (No in Step S003), the estimation unit 116 proceeds the processing to Step S005. Meanwhile, when it is determined that an intersection is present (Yes in Step S003), the estimation unit 116 estimates that a user desires to travel to a destination along a route different from the recommended route, and prepares for rerouting (Step S004).

Note that, when it is determined that an intersection is present, the estimation unit 116 may acquire output information from a direction indicator through the communication unit 130 via the CAN, and may execute determination for estimating whether a user desires to travel on a route different from the recommended route (determination in Step S003), also using the information.

As preparation for rerouting, the estimation unit 116 instructs the route information acquisition unit 113 to acquire a rerouting route. The route information acquisition unit 113 transmits a request for acquiring the rerouting route to the server device 300 via the communication unit 130, the rerouting route being a route along which the vehicle travels to the destination by turning right or left at the intersection. Then, the route information acquisition unit 113 acquires the route information 122 relating to the rerouting route from the server device 300. Note that, when the output information is acquired from the direction indicator, the route information acquisition unit 113 sets a road after tuning at the intersection as a starting point of the rerouting route, and transmits, to the server device 300, a request for acquiring the rerouting route from the starting point to the destination.

After instructing the route information acquisition unit 113 to acquire the rerouting route, the estimation unit 116 returns the processing to Step S001.

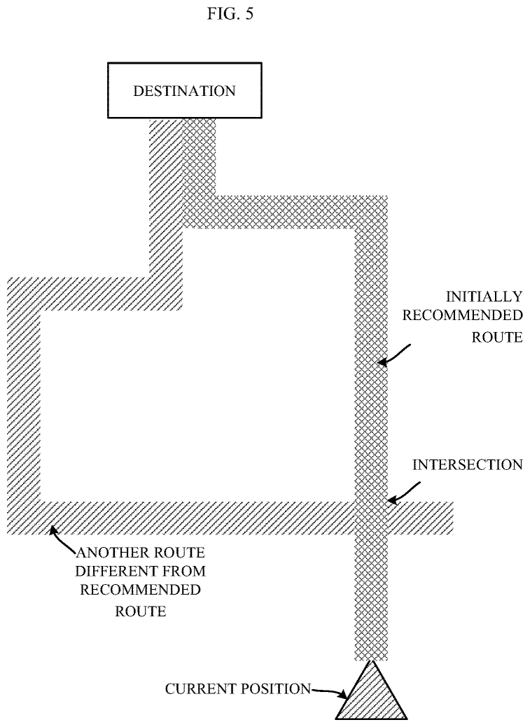

FIG. 5 is a diagram illustrating an outline of reroute processing. As illustrated, in a case where a deceleration operation or vehicle deceleration is detected, and the automatic drive control system 200 determines that deceleration is unnecessary, when it is determined that an intersection is closely present, the estimation unit 116 estimates that a user desires to travel to a destination along another route taking a turn at the intersection, instead of the initially recommended route. In this case, via the route information acquisition unit 113, the estimation unit 116 acquires, from the server device 300 in advance, the rerouting route taking a turn at the intersection.

Note that, when the vehicle actually turns at the intersection, and the own vehicle position moves to (matches with) the road being the starting point of the rerouting route, the estimation unit 116 displays the rerouting route, which is acquired in advance, on the display device 420 via the output processing unit 112.

Description is given referring back to FIG. 4. In a case where it is determined that, in Step S003, no intersection is present ahead on the road along which the own vehicle travels and within a prescribed distance (for example, within 50 m) from the own vehicle position (No in Step S003), the estimation unit 116 determines whether the direction indicator flashes on a sidewalk side in the processing in Step S005. Specifically, the estimation unit 116 determines whether the direction indicator flashes on the sidewalk side by whether the output information of the direction indicator to the sidewalk side (left side) is acquired through the communication unit 130 via the CAN.

When it is determined that the direction indicator does not flash on the sidewalk side (No in Step S005), the estimation unit 116 proceeds the processing to Step S008. Meanwhile, when it is determined that the direction indicator flashes on the sidewalk side (Yes in Step S005), the estimation unit 116 uses the normal map information 121 to determine whether a prescribed facility (for example, a bank, a convenience store, a restaurant, a shopping mall, a department store, a city hall, or the like) is present on the side indicated by the direction indicator (Step S006).

When it is determined that the prescribed facility is not present on the side indicated by the direction indicator (No in Step S006), the estimation unit 116 proceeds the processing to Step S008. Meanwhile, when it is determined that the prescribed facility is present (Yes in Step S006), the estimation unit 116 estimates that a user desires to enter the facility along the road, and specifies detailed information relating to the facility by using the normal map information 121. The estimation unit 116 displays the specified detailed information relating to the facility (for example, business hours, characteristics of services the facility provides, and the like) on the display device 420 via the output processing unit 112 (Step S007).

Note that, when a plurality of facilities are present on the side indicated by the direction indicator, the estimation unit 116 may specify a facility closest to the vehicle at the time of determination in Step S006, and may display detailed information relating the facility on the display device 420 via the output processing unit 112. Alternatively, the estimation unit 116 may generate list information in which pieces of information relating to the plurality of facilities are listed in the order from the facility closest from the vehicle at the time of determination in Step S006, and may display the list information on the display device 420 via the output processing unit 112.

When an in-vehicle camera that captures an image of a sight direction of a user is installed on the vehicle, the estimation unit 116 may acquire information relating to the sight direction of the user via the communication unit 130, and may estimate whether a user desires to enter the facility along the road by using such information.

After displaying the information relating to the facility via the output processing unit 112, the estimation unit 116 returns the processing to Step S001.

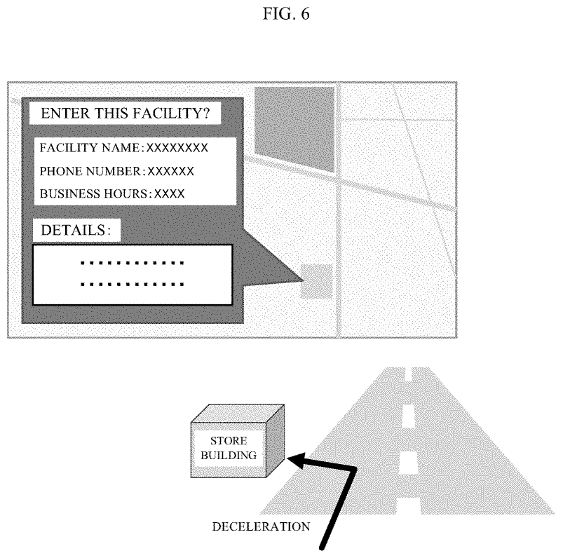

FIG. 6 is a diagram illustrating an outline of processing for displaying facility information. As illustrated, in the case where a deceleration operation or vehicle deceleration is detected, and the automatic drive control system 200 determines that deceleration is unnecessary, when it is determined that a prescribed facility is present on the sidewalk side indicated by the direction indicator, the estimation unit 116 estimates that a user desires to enter the facility. In this case, the estimation unit 116 specifies the detailed information relating to the facility from the normal map information 121, and displays the detailed information on the display device 420 via the output processing unit 112. The displayed information relating to the facility contain, for example, a facility name, a phone number, business hours, services the facility provides, and the like.

Description is given referring back to FIG. 4. When it is determined that the direction indicator does not flash on the sidewalk side in Step S005 (No in Step S005), or it is determined that a prescribed facility is not present on the side indicated by the direction indicator (No in Step S006), the estimation unit 116 estimates that a user desires to stop or park the vehicle for some reason in the processing in Step S008, and causes the vehicle to travel to a place where a user can safely stop or park the vehicle, while switching to the automatic drive.

Specifically, the estimation unit 116 instructs the automatic drive control unit 210 to switch to the automatic drive mode, via the communication unit 130. In this case, the estimation unit 116 specifies a prescribed place where a user can safely stop or park the vehicle (for example, a nearest parking space or a road shoulder along the road where stopping/parking is allowed) by using the route information 122, and calculates a route to the place. The estimation unit 116 transmits information containing the specified place and the route to the place as well as the instruction of switching to the automatic drive mode, to the automatic drive control unit 210 via the communication unit 130.

Note that, the automatic drive control unit 210 may specify the place where stopping/parking is allowed, and may calculate the route to the place. For example, when acquiring the instruction of switching to the automatic drive mode, the automatic drive control unit 210 sets the automatic drive mode, specifies a prescribed place where a user can safely stop or park the vehicle (for example, a nearest parking space or a road shoulder along the road where stopping/parking is allowed) by using the route information 122, and calculates a route to the place. The automatic drive control unit 210 outputs an instruction to each ECU via the communication unit 230, and causes the vehicle to travel to the specified place through the automatic drive.

After instructing the automatic drive control unit 210 to switch to the automatic drive mode, the estimation unit 116 returns the processing to Step S001.

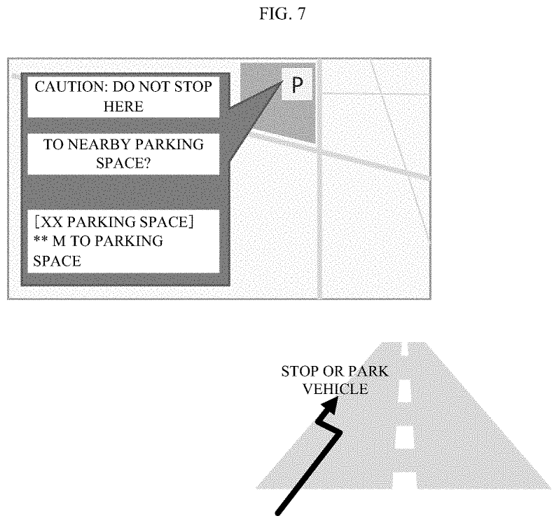

FIG. 7 is a diagram illustrating an outline of processing for switching to automatic drive and causing a vehicle to travel. As illustrated, in the case where a deceleration operation or vehicle deceleration is detected, and the automatic drive control system 200 determines that deceleration is unnecessary, when an intersection is not closely present, and the direction indicator does not flash, or when a prescribed facility is not present on the side indicated by the direction indicator, the estimation unit 116 estimates that a user desires to stop or park the vehicle for some reason.

In this case, as illustrated, the estimation unit 116 may display, on the display device 420, a confirmation message whether to switch to the automatic drive and travel to a place where stopping/parking is allowed (for example, a nearest parking space), and may receive an instruction from a user.

Note that, when a user issues an instruction of switching to the automatic drive via an input device (not illustrated) installed on the vehicle, the estimation unit 116 acquires the instruction through the communication unit 130 via the CAN, and transmits the instruction of switching to the automatic drive mode, to the automatic drive control unit 210. When the automatic drive mode is set, the automatic drive control unit 210 causes the vehicle to travel to a place where a user can safely stop or park the vehicle, through the automatic drive.

A case where a user does not desire the automatic drive is conceivable. Thus, when it is estimated that a user desires to stop or park the vehicle for some reason in the processing in Step S008, the estimation unit 116 may not output an instruction of switching to the automatic drive mode to the automatic drive control unit 210, and may perform navigation by displaying a route or a distance to a nearest parking space or a road shoulder where a user can safely stop or park the vehicle, on the display device 420 via the output processing unit 112.

The drive assist processing executed by the drive assist device 100 is described above. According to the drive assist device 100 as described above, it can be estimated accurately whether deceleration is intended to deviate from a scheduled route, and a drive assist can be performed in accordance with the estimated intention. Particularly, the drive assist device 100 utilizes the result of deceleration necessity determination, which is executed by the automatic drive control system 200 in the background, and determines whether a deceleration operation is performed when deceleration is unnecessary. With this, it can be determined more accurately whether a user intends deviation from the scheduled route. The drive assist device 100 estimates an intention for deceleration of a user in accordance with a surrounding environment, and thus is capable of executing an appropriate drive assist in accordance with the estimation result.

### Modification Examples

In the embodiment described above, it is estimated whether a user desires to deviate from the scheduled route by utilizing the result of frontward confirmation determination and deceleration necessity determination, which are executed by the automatic drive control system 200 in the background. However, the present invention is not limited to the embodiment. In a first modification example, the drive assist device 100 executes the frontward confirmation determination and the deceleration necessity determination.

Specifically, the deceleration necessity determination result acquisition unit 114 of the drive assist device 100 executes the frontward recognition determination by using information from an on-board camera and various sensors such as a millimeter wave radar. The deceleration necessity determination result acquisition unit 114 specifies an own vehicle position (current position) on the recommended route by using the information output from the GPS reception device 490 and the route information 122. Similarly to the automatic drive control unit 210, the deceleration necessity determination result acquisition unit 114 executes the deceleration necessity determination on whether vehicle deceleration is necessary or unnecessary, based on the determination result of frontward confirmation and the own vehicle position. Similarly in the embodiment described above, the estimation unit 116 executes the drive assist processing by using the result of deceleration necessity determination.

In other words, in a case where the scheduled route (recommended route) indicates going straight, and a user performs a deceleration operation although an obstacle or the like that forcibly causes deceleration is not present ahead, when an intersection allowing a right/left turn is present near the own vehicle position, the drive assist device 100 in the first modification example estimates that a user desires to travel to a destination along another route different from the scheduled route, and acquires a rerouting route taking a turn right or left at the intersection in advance. When the vehicle actually turns right or left at the intersection, and the own vehicle position matches the rerouting route, the drive assist device 100 displays the rerouting route on the display device 420.

Alternatively, in a case where the scheduled route (recommended route) indicates going straight, and a lighting color of a traffic light present ahead is blue, and a user performs a deceleration operation although an obstacle or the like that forcibly causes deceleration is not present ahead, the drive assist device 100 estimates that a user desires to travel to a destination along another route different from the scheduled route, and executes the processing similar to one described above.

Alternatively, in case where the scheduled route (recommended route) indicates going straight, and a user performs a deceleration operation although an obstacle or the like that forcibly causes deceleration is not present ahead, and an intersection allowing a right/left turn is not present near the own vehicle position, the drive assist device 100 estimates that a user desires to enter a facility on the sidewalk side or to stop or park the vehicle, and displays the information relating to the facility on the display device 420 or causes the vehicle to travel to a nearest parking space where a user can safely stop or park the vehicle or a road where stopping/parking is allowed, through the automatic drive. Note that, instead of transmitting an instruction of switching to the automatic drive to the automatic drive control system 200, the drive assist device 100 may display, on the display device 420, a route or a distance to a nearest parking space where a user can safely stop or park the vehicle or a road where stopping/parking is allowed.

Also with the drive assist device 100 in the first modification example, it can be estimated accurately whether deceleration is intended to deviate from a scheduled route, and a drive assist can be performed in accordance with the estimated intention.

Note that the drive assist device 100 in the first modification example may be used in the vehicle without installing the automatic drive control system 200 thereon. The drive assist device 100 in a second modification example, which is used in the vehicle without installing the automatic drive control system 200 thereon, is not capable of switching to the automatic drive in the drive assist processing in Step S008. Thus, the estimation unit 116 guides a user by displaying a position of a nearest parking space or a road shoulder where the user can safely stop or park the vehicle, on the display device 420 via the output processing unit 112.

Also with the drive assist device 100 in the second modification example, it can be estimated accurately whether deceleration is intended to deviate from a scheduled route, and a drive assist can be performed in accordance with the estimated intention. Particularly, the drive assist device 100 in the second modification example can be used in the vehicle without installing the automatic drive control system 200 thereon, and hence can improve usability.

The processing in Step S008 in the embodiment described above is executed when the direction indicator does not flash on the sidewalk side (No in Step S005) or when a facility is not present on the side indicated by the direction indicator (No in Step S006). However, in the drive assist device 100 in a third modification example, determination conditions may further include whether a mobile terminal of a user receives an incoming call or receives an e-mail in the processing in Step S005 and Step S006.

Specifically, under a state in which a mobile terminal of a user and the drive assist device 100 are connected each other in accordance with a prescribed short-distance radio communication standard such as Bluetooth (registered trademark), when the mobile terminal receives an incoming call or receives an e-mail, the input reception unit 111 detects the reception. When the determination in Step S005 or Step S006 is executed, the estimation unit 116 also determines whether the input reception unit 111 detects reception of an incoming call or an e-mail in addition to the determination in each step.

When reception of an incoming call or an e-mail is detected, the estimation unit 116 estimates that an intention for deceleration of a user is to stop the vehicle so as to take the call or read the e-mail, and executes the processing in Step S008.

With the drive assist device 100 in the third modification example, a drive assist that reflects an intention for deceleration of a user more can be executed.

The drive assist device 100 in a fourth modification example may store a place where a drive assist is executed, specifically, a location where a deceleration operation is performed although deceleration is determined to be unnecessary, and deviation from the scheduled route is started. Such information may be fed back to processing such as automatic drive control executed by the automatic drive control system 200 or a route search executed by the drive assist device 100, thereby utilizing the feedback for the next and succeeding automatic drive control or route search.

In the embodiment described above, the drive assist device 100 acquires the route information 122 containing a recommended route from the server device 300. However, the drive assist device 100 may perform route search by using highly accurate map information, and may generate the route information 122 containing a recommended route.

The present invention is not limited to the embodiments and the modification examples given above, and includes various embodiments and modification examples other than those. For example, the embodiments given above are described in detail for the sake of better understanding of the present invention, and the present invention is not necessarily limited to including all the configurations described herein. Moreover, a part of a configuration of an embodiment can be replaced with a configuration of another embodiment or a modification example, and a configuration of another embodiment can be added to a configuration of an embodiment. Another configuration can be added to, deleted from, and replaced with a part of a configuration of each embodiment.

What is claimed is:

1. A drive assist device comprising:
a route information acquisition unit configured to acquire route information containing a recommended route for a vehicle to travel to a destination;
a deceleration detection unit configured to detect a deceleration operation or deceleration of the vehicle;
a deceleration necessity determination result acquisition unit configured to acquire a result of deceleration necessity determination on whether deceleration is necessarily forced, based on a vehicle surrounding environment and the route information; and
an estimation unit configured to estimate a prescribed deceleration intension in a case where deceleration of the vehicle or a deceleration operation is detected and the result of deceleration necessity determination indicates that deceleration is unnecessary, and execute processing for a drive assist in accordance with a result of the estimation.

2. The drive assist device according to claim 1, further comprising:
a storage unit configured to store map information, wherein
the estimation unit
in the case where deceleration the of vehicle or the deceleration operation is detected and the result of deceleration necessity determination indicates that deceleration is unnecessary, determines whether an intersection is present near the vehicle by using the map information, and
the route information acquisition unit
when it is determined that the intersection is present, acquires a rerouting route for taking a turn at the intersection and traveling to the destination.

3. The drive assist drive according to claim 2, further comprising:
an output processing unit configured to generate screen information to be displayed on a display device, wherein
when the vehicle travels to a road on the rerouting route after turning at the intersection, the output processing unit displays the rerouting route on the display device.

4. The drive assist device according to claim 1, further comprising;
a storage unit configured to store map information, wherein
the estimation unit
in the case where deceleration of the vehicle or the deceleration operation is detected and the result of deceleration necessity determination indicates that deceleration is unnecessary, determines whether a direction indicator of the vehicle flashes and whether a prescribed facility is present in a direction indicated by the direction indicator, by using the map information, and
when it is determined that the prescribed facility is present, specifies information relating to the facility.

5. The drive assist device according to claim 4, further comprising:
an output processing unit configured to generate screen information to be displayed on a display device, wherein
the output processing unit displays information relating to the facility being specified, on the display device.

6. The drive assist device according to claim 1, further comprising:
a storage unit configured to store map information, wherein
the estimation unit
in the case where deceleration of the vehicle or the deceleration operation is detected and the result of deceleration necessity determination indicates that deceleration is unnecessary, determines whether a direction indicator of the vehicle flashes and whether a prescribed facility is present in a direction indicated by the direction indicator, by using the map information, and
when it is determined that the direction indicator does not flash, or it is determined that the prescribed facility is not present, specifies a navigation route to a place allowing safe stopping/parking, by using the map information.

7. The drive assist device according to claim 6, further comprising:
an output processing unit configured to generate screen information to be displayed on a display device, wherein
the output processing unit displays a navigation route to the place being specified, on the display device.

8. The drive assist device according to claim 1, further comprising:
a communication unit configured to communicate with an automatic drive control unit that is configured to control the vehicle to execute automatic drive; and
a storage unit configured to store map information, wherein
the estimation unit
in the case where deceleration of the vehicle or the deceleration operation is detected and the result of deceleration necessity determination indicates that deceleration is unnecessary, determines whether a direction indicator of the vehicle flashes and whether a prescribed facility is present in a direction indicated by the direction indicator, by using the map information, and
when it is determined that the direction indicator does not flash, or it is determined that the prescribed facility is not present, specifies a navigation route to a place allowing safe stopping/parking, and
the communication unit
transmits an instruction, to the automatic drive control unit, for causing the vehicle to travel to the place being specified, through automatic drive.

9. The drive assist device according to claim 1, wherein
the deceleration necessity determination is executed by an automatic drive control unit configured to control the vehicle to execute automatic drive.

10. A program causing a computer to function as a drive assist device, the program causing the computer to function as:
a route information acquisition unit configured to acquire route information containing a recommended route for a vehicle to travel to a destination;
a deceleration detection unit configured to detect a deceleration operation or deceleration of the vehicle;
a deceleration necessity determination result acquisition unit configured to acquire a result of deceleration necessity determination on whether deceleration is necessarily forced, based on a vehicle surrounding environment and the route information; and
an estimation unit configured to estimate a prescribed deceleration intension in a case where deceleration of the vehicle or a deceleration operation is detected and the result of deceleration necessity determination indicates that deceleration is unnecessary, and execute processing for a drive assist in accordance with a result of the estimation.
